(19) United States
(12) Patent Application Publication
(10) Pub. No.: US 2009/0002124 A1
(43) Pub. Date: Jan. 1, 2009

(54) Apertured chip resistor and method for fabricating same

(75) Inventor: Rong-Tzer TSAI, Kaohsiung (TW)

Correspondence Address: Muncy, Geissler, Olds & Lowe, PLLC, P.O. BOX 1364, FAIRFAX, VA, 22038-1364, US

(73) Assignee: FEEL CHERNG ENTERPRISE CO., LTD.

(21) Appl. No.: 12/153,146

(22) Filed: May 14, 2008

(30) Foreign Application Priority Data
Jun. 29, 2007 (TW) 096123656

(51) Int. Cl. H01C 1/012; H01C 17/00

(52) U.S. Cl. 338/308; 29/610.1

(57) ABSTRACT

An apertured fixed chip resistor and method for fabricating the same are disclosed according to the present invention, wherein a bonding layer is applied to accordingly bond together a substrate and a metallic sheet structure that has central aperture, and then a passivation layer is applied to partially cover the exposed surface of the metallic sheet structure and to divide the surface of the metallic sheet structure into a central covered region separating two uncovered regions, wherein the uncovered regions are provided to serve as electrode zones, thereby eliminating unnecessary current transmission impedance as in prior art as well as efficiently and stably reducing the temperature coefficient of resistance. The bonding design of the substrate and the metallic sheet structure of the present invention is capable of overcoming the drawback of the high cost of semiconductor processing as applied in prior art, and it provides a simple fabrication process that is capable of increasing process yield and decreasing total production costs.

### BACKGROUND OF THE INVENTION

1. Field of the Invention

This invention generally relates to chip resistors, and more specifically, to an apertured chip resistor and a method for fabricating the same.

2. Description of Related Art

In accordance with the trend towards microminiaturization and portability of various electronic devices, fixed chip resistors—which are frequently applied in circuits for measuring the electric potential difference between two terminals—are accordingly trending towards microminiaturization as well. But in order to reduce measurement errors as well as raise detected current values, and to reduce the temperature coefficient of resistance, resistors with resistances ranging from 0.02Ω to 10Ω that are capable of handling high power with wattage ratings often over 0.1 W are commonly demanded. However, printing and coating techniques, which are presently the most applied fabrication techniques of the prior arts, have practical disadvantages that hinder mass production at low cost.

A chip resistor has been disclosed according to the claims of R. O. C. Patent No. 350071, wherein a resistant film, which is a resistant adhesive made of a mixture of glass and electro-conductive particles, is printed on a ceramic substrate by means of screen printing technique, and, subsequently the resistant film is shaped via the processes of drying, high sintering, and others. Then, a part of the resistant film is melted down to form a trench for adjusting the resistance through a laser tuning process, and then electrodes are made through an electroplating process. However, the resistant film is formed by means of printing technique, and it is difficult to control the uniformity of thickness of the resistant film. And due to the effect of broadening the variance at high sintering, the variability of resistance of the resistant film is great. This is especially significant when the aforementioned chip resistor is applied in a high frequency environment, because the resistant film has high porosity and a loose structure and consequently causes high-frequency signals to degrade greatly. Therefore it is not applicable to or ideal for high-frequency products.

In another fabrication method that applies coating technique, a resistant film is formed on a ceramic substrate in a semiconductor fabrication process by means of physical vapor deposition (PVD) or chemical vapor deposition (CVD), such as sputter deposition or evaporation deposition or others. However, since these methods of fabricating chip resistors involve semiconductor fabrication processing, the required equipment investment is high, and also the semiconductor process yield has its limitations, making the overall production cost quite high, thereby greatly decreasing the competitive advantage of such products. Moreover, in the aforementioned semiconductor process, the resistant film is formed in a patterning process via photolithography, wherein photoresist film has to be removed before proceeding to subsequent processes. However, in the process of removing the photoresist film, the situation of incomplete removal or excessive removal often happens. Consequently, the resistant film is easily exposed, and it can then get contaminated or become oxidized, thereby affecting its electrical properties, and accordingly decreasing the fabrication process yield.

In order to overcome the aforementioned drawbacks, a fabrication method has been disclosed according to the claims of R. O. C. Patent No. 1237898, wherein two base electrodes are first separately formed on two ends of an insulated substrate. Next, a resistant film is formed on the upper surface of the insulated substrate by means of thin film deposition. Afterwards, a passivation layer is formed on the resistant film formed in the previous step by means of printing, wherein the passivation layer covers at least part of the resistant film between the two main electrodes but exposes part of the resistant film in the regions of the two main electrodes. Moreover, the passivation layer that covers between the two main electrodes extends continuously, and subsequently the first passivation layer is used as a cover to remove the uncovered resistant film by chemical etching. Finally, two terminals are formed on top the two base electrodes of the insulated substrate, wherein each separately covers its corresponding main electrode.

However, the foregoing technique still applies semiconductor fabrication processing. Consequently, the problems of high cost and poor yield are still unsolved; and the coating process for the passivation layer raises the cost even more. In addition, the resistant film is indirectly electrically connected to the plane electrodes via the main electrodes, thereby increasing the temperature coefficient of resistance of the resistance film and the main electrodes, and consequently the temperature coefficient of resistance of the fabricated chip resistor can not be reduced to the demanded value, and also the heat dissipation efficiency is significantly decreased.

In summary, the aforementioned prior art has the drawbacks of a low fabrication process yield, unavoidably high equipment and production costs, incapability of reducing the temperature coefficient of resistance to demanded values, and others. Therefore, it is a greatly desirable in the industry to provide a chip resistor and method for fabricating the same that can effectively solve the aforementioned drawbacks.

### SUMMARY OF THE INVENTION

In view of the disadvantages of the prior art mentioned above, it is a primary objective of the present invention to provide an apertured fixed chip resistor and method for fabricating the same that are capable of stably decreasing the temperature coefficient of resistance to a demanded value.

It is another objective of the present invention to provide an apertured fixed chip resistor and method for fabricating the same that have a simple fabrication process and are capable of increasing the fabrication process yield.

It is a further objective of the present invention to provide an apertured fixed chip resistor and method for fabricating the same that are capable of decreasing the production cost.

To achieve the aforementioned and other objectives, an apertured fixed chip resistor is provided according to the present invention. The apertured fixed chip resistor includes: a substrate; a metallic sheet structure, which has a central aperture that is for defining the resistance of the resistor; a bonding layer, which bonds the substrate and the metallic sheet structure together in face-to-face orientation; and a passivation layer, which partially covers the surface of the metallic sheet structure, dividing it into a central covered region and two uncovered regions with the central region therebetween, wherein the two uncovered regions serve as electrode zones.

In the foregoing apertured fixed chip resistor, the basic required property of the substrate is that it capable of acting as an insulator. Other than that, there are no specified restrictions. A ceramic substrate is applicable, for instance. The basic required property of the metallic sheet structure is that its resistance must be pre-defined. In one embodiment, the metallic sheet structure is a metal alloy of copper and manganese and tin, while in another embodiment, the metallic sheet structure is a metal alloy of copper and manganese and nickel. The basic principle of the central aperture of the metallic sheet structure is that the area of the central aperture is calculable from its shape, and then the resistance of the metal sheet structure can be obtained from the size of the central aperture. Other than that, there are no specified restrictions. Any of the shapes of circle, square, rhombus, trapezoid, and regular polygon is applicable. The resistance of the metallic sheet structure is defined by the area of the central aperture, wherein the resistance and the central aperture area are in direct proportion. For example, take the case where the central aperture is a circle, the bigger the diameter of the aperture, the larger the resistance (since there would be less metal remaining to conduct electrons).

The aforementioned bonding layer can be either an entire layer of solder bumps or at least two alternate solder bumps. Basically, the passivation layer provides protection for the entire metallic sheet structure except the two electrode zones. In one embodiment, the passivation layer covers the surface of the central region of the metallic sheet structure, thereby forming two electrode zones on two opposite sides divided by the central region of the metallic sheet structure. In another embodiment, an electrode is further separately formed on each of the two electrode zones of the metallic sheet structure, thus providing a means for soldering to, for instance, a circuit board that needs to measure electric potential difference. In one preferred embodiment, the electrodes are formed on the electrode zones by means of rolling plating.

In order to achieve the same aforementioned objectives, a method for fabricating, an apertured fixed chip resistor is further disclosed according to the present invention, the method comprising: providing a substrate and a metallic sheet structure, wherein the metallic sheet structure has a central aperture that is for defining its resistance; bonding the substrate and the metallic sheet structure together in face-to-face orientation via a bonding layer; and forming a passivation layer to partially cover the surface of the metallic sheet structure such that it divides the surface of the metallic sheet structure into a central covered region and two opposite uncovered regions with the covered region therebetween, wherein the two uncovered regions font two electrode zones.

In the foregoing method, the central aperture of the metallic sheet structure can be made by means of either stamping or machining, wherein the means of stamping can be a punching process, and the means of machining can be either a drilling process or a milling process.

The bonding layer can be at least two alternate solder bumps, wherein there are no restrictions on the shape and size of the solder bumps. In one embodiment, a solder material is pre-coated on a surface of the substrate, and then the metallic sheet structure is affixed on the substrate, and, after being through a thermic welding process, the solder material transforms into solder bumps that bond the substrate and the metallic sheet structure together. In another embodiment, a solder material is pre-coated on a surface of the metallic sheet structure, and then the metallic sheet structure is affixed on the substrate, and, after being through a thermic welding process, the solder material transforms into solder bumps that bond the substrate and the metallic sheet structure together. In these methods, it is better that the solder material has a temperature coefficient of resistance closer to those of the substrate and the metallic sheet structure, and that the solder material has better thermo-conductivity. Besides that, there are no specific restrictions on the solder material; it can be a silver paste, for instance.

In view of the aforementioned descriptions, the apertured fixed chip resistor and method for fabricating the same of the present invention has the following main features: by applying a bonding layer to bond the substrate and the metallic sheet structure together, the present invention is capable of eliminating the drawback of the high cost of applying semiconductor fabrication processing and consequently achieving the objectives of a simple fabrication process, increasing fabrication process yield, and decreasing total production costs. The surface of the part of the metallic sheet structure not covered by the passivation layer is divided to directly form two electrode zones, which provide a means for either a direct soldering application or for further forming electrodes that are advantageous for soldering, thereby eliminating unnecessary current transmission impedance as in the prior art, as well as effectively and stably reducing the temperature coefficient of resistance.

### BRIEF DESCRIPTION OF DRAWINGS

The present invention can be more fully understood by reading the following detailed description of the preferred embodiments, with reference made to the accompanying drawings, wherein:

FIGS. 1A through 1F are flow chart diagrams of the first embodiment of the fabrication method of an apertured chip resistor according to the present invention;

FIGS. 2A through 2F are flow chart diagrams of the second embodiment of a fabrication method of an apertured chip resistor according to the present invention; and

FIG. 3 is a diagram illustrating the heat conduction in an application state of the apertured chip resistor of the present invention.

### DETAILED DESCRIPTION OF PREFERRED EMBODIMENTS

The following illustrative embodiments are provided to illustrate the disclosure of the present invention; these and other advantages and effects can be readily understood by those in the art after reading the disclosure of this specification. The present invention can also be performed or applied by other differing embodiments. The details of the specification may be changed on the basis of different points and applications, and numerous modifications and variations can be devised without departing from the spirit of the present invention.

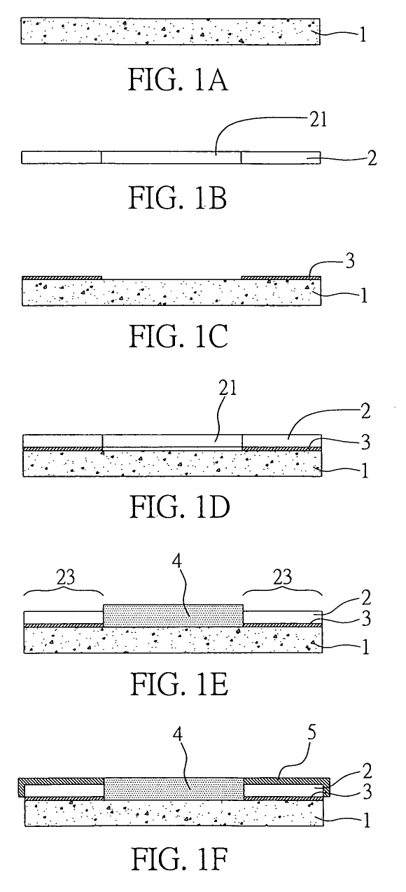

FIGS. 1A through 1G are flow chart diagrams of the first embodiment of fabrication method of apertured fixed chip resistor according to the present invention. As shown in the figures, the fabrication method for an apertured fixed chip resistor provided by the present invention comprises but is not restricted to the following descriptions.

As shown in FIGS. 1A and 1B, first a substrate 1 and a metallic sheet structure 2 that has a central aperture 21 are provided, wherein the substrate 1 is, for example, a ceramic substrate that is mainly made of aluminate oxide, the basic required property of the substrate being that it has an insulative nature, but, other than that, there are no specified restrictions. The resistance of the metallic sheet structure 2 is defined by its central aperture 21. In the present embodiment, the metallic sheet structure 2 is a metal alloy of copper and manganese and tin, but is not limited to such composition. In another embodiment, the metallic sheet structure 2 can be a metal alloy of copper and manganese and nickel. The basic principle of the central aperture 21 is that its area must be calculable from its shape in order to convert the area into resistance. Besides that, there are no specific restrictions. For example, any of the shapes of circle, square, rhombus, trapezoid, and regular polygon is applicable. The central aperture can be pre-formed by means of stamping or machining, wherein the means of stamping can be a punching process, for instance, and the machining process can be, for instance, either a drilling process or a milling process.

As shown in FIGS. 1C and 1D, next, the substrate 1 and the metallic sheet structure 2 are bonded together in face-to-face orientation via a bonding layer 3, wherein the bonding layer 3 can be at least two alternate solder bumps, thereby providing a means for further adjusting the resistance of the metallic sheet structure 2 by adjusting the width and opposed positions of the two solder bumps. There are no specific restrictions on the sequence of forming the bonding layer 3. In the present embodiment, a solder material is pre-coated on the top surface of the substrate 1, and then the metallic sheet structure 2 is affixed on the substrate 1, and, after that, via a thermic welding process, the solder material transforms into the bonding layer 3 of, for instance, solder bumps that bond the substrate and the metallic sheet structure together; the said solder material being silver paste, for example.

Naturally, the said bonding layer 3 is not limited to the application of at least two solder bumps; any bonding material that is applicable to a thermic welding process and also has good thermo-conductivity is acceptable. For example, an entire layer of silver paste can be printed on the substrate 1, and then the substrate 1 and the metallic sheet structure 2 can be bonded together via a baking welding process and a drying process. The said entire layer of silver paste basically equals the aforesaid bonding layer 3 of the two solder bumps, but is not limited to the two solder bumps as illustrated in the present embodiment. In addition, the stated baking and drying processes for solidifying are equivalent to a reflow process, and the solder material can be baked at 250, and then let dry naturally at room temperature, but the process is not restricted to that stated herein; any means that is capable of baking and drying and solidifying is suitable with the said thermic welding process according to the present invention.

As shown in FIG. 1E, next, a passivation layer 4 is formed to partially cover the metallic sheet structure 2 such that it divides the surface of the metallic sheet structure 2 into a central covered region and two opposed uncovered regions with the central region therebetween, wherein the two uncovered regions serve as electrode zones 23. Thus far, a basic apertured fixed chip resistor is complete. The basic required property of the said passivation layer 4 is that it provides insulation. In the present embodiment, an insulating material, such as an epoxy resin or others, is applied to cover the central region of the metallic sheet structure 2, extending to the lateral surfaces, by means of coating, and, consequently forming two electrode zones 23 on the two ends of the metallic sheet structure 2 oppositely divided by the central region. In one practical application, the two divided electrode zones 23 formed by dividing the metallic sheet structure 2 are capable of being directly soldered to an external device, for instance, directly soldering to preset circuits of a circuit board.

As shown in FIG. 1F, in order to provide convenience in soldering in subsequent practical application, an electrode 5 can further be separately formed on each of the two electrode zones 23 of the metallic sheet structure 2, thus providing a means for soldering to, for instance, a circuit board that needs to measure electric potential difference. In a preferable embodiment, the electrodes are formed on the electrode zones by means of rolling plating, but the formation means is not limited to this method; any means that is capable of forming the electrodes 5 on surfaces of the electrode zones 23 is applicable, the basic condition being that no medium is required for connecting between the electrodes 5 and the electrode zones 23. For instance, neither electroplating nor thermo compression bonding needs to use a medium, therefore both are applicable means; and since the electrodes are formed to provide a convenient means for soldering externally, the electrodes 5 are preferably made of alloy containing tin, for instance, a metal alloy of copper and nickel and tin.

It should be noted herein that all the illustrative diagrams of this embodiment are based on the fabrication method of a single apertured fixed chip resistor, but these are not restrictive of the technological ideas of the present invention. For example, any commonly used batch production method can be used. For instance, a plurality of the aforesaid ceramic substrates 1 can be integrated and arranged into the state of a matrix pattern. Also, a plurality of the aforesaid fixed resistors 2 can be integrated and arranged into the state of matrix pattern, and, after a plurality of apertured fixed chip resistors are synchronously completed in subsequent processes, a cutting process can be performed to singulate the chip resistors. Fabrication steps based on the technological ideas of the present invention should be construed to fall within the scope of the present invention; and since the applied synchronous process of batch production and cutting can be clearly understood by those in the art, no further explanations are provided herein.

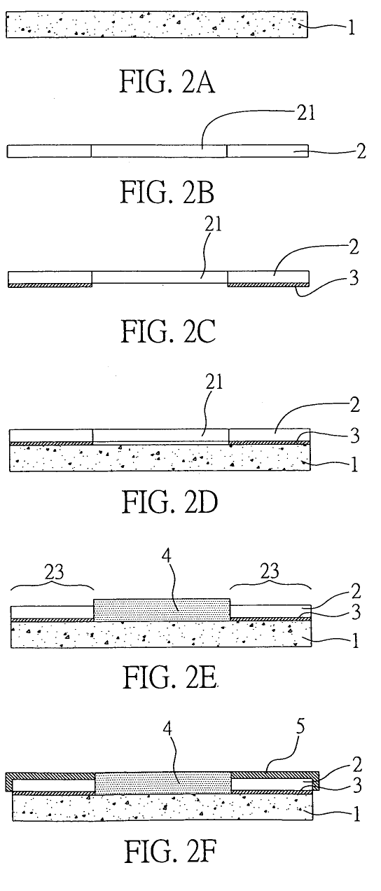

Please refer to FIGS. 2A through 2G, which are flow chart diagrams of the second embodiment of the fabrication method for an apertured fixed chip resistor of the present invention; wherein the disclosed fabrication method for an apertured fixed chip resistor comprises steps mostly similar to that of the previous disclosed first embodiment. There is no change in the fabricated structure of the apertured fixed chip resistor, and, in order to simplify the illustrative description of the present embodiment, like elements will adopt the same labels; with only differing features described in detail.

As shown in FIGS. 2A and 2B, first, a substrate 1 and a metallic sheet structure 2 that has central aperture 21 are provided, wherein the character and variation of both said substrate 1 and said metallic sheet structure 2 are the same as those of the first embodiment, therefore no further description is provided.

As shown in FIGS. 2C and 2D, next, the substrate 1 and the metallic sheet structure 2 are bonded together in face-to-face orientation via a bonding layer 3, wherein the bonding layer 3 can be either at least two alternate solder bumps or an entire layer of solder material as aforementioned. There are no specific restrictions on the sequence of forming the bonding layer 3. In the present embodiment, the bonding layer 3 consists of two solder bumps, wherein a solder material is pre-coated on the surface of the metallic sheet structure 2, and then the metallic sheet structure 2 is affixed on the substrate 1. After that, the solder material transforms into the bonding layer 3 of solder bumps that bond the substrate 1 and the metallic sheet structure 2 together through a thermic welding process, wherein the said solder material is a silver paste, for example. The property and variation of the bonding layer 3 is the same as that of the first embodiment, therefore no further details are provided.

As shown in FIGS. 2E and 2F, the subsequent step of forming a passivation layer 4, and, according to practical demands, the step of separately forming an electrode 5 on the surface of each of the two electrode zones 23, as well as the properties and variations of the passivation layer 4 and electrodes 5 are all the same as those of the first embodiment, therefore further description is not provided herein.

In addition, as shown in FIGS. 1E and 2E, the present invention further provides an apertured fixed chip resistor, which comprises: a substrate 1; a metallic sheet structure 2 that has central aperture 21; a bonding layer 3 that bonds the substrate 1 and the metallic sheet structure 2 together in face-to-face orientation; and a passivation layer 4 that partially covers the metallic sheet structure 2, such that the passivation layer 4 divides the surface of the metallic sheet structure 2 into a central covered region and two opposed uncovered regions with the central region therebetween, wherein the two uncovered regions serve as electrode zones 23. Meanwhile, the resistance of the metallic sheet structure 2 is defined by the area of the central aperture 21, and the resistance and the area of the central aperture 21 are in direct proportion. That is, if the central aperture 21 is a circle, for example, then the bigger its diameter, the larger the resistance.

The properties and structure variations of said substrate 1, metallic sheet structure 2, bonding layer 3, and passivation layer 4 are all the same as those of the previously disclosed fabrication methods; therefore, the descriptions are not repeated herein. In addition, the apertured fixed chip resistor of the present invention, as shown in FIG. 1F or 2F, can further comprise electrodes 5, which are separately formed on the top surfaces of the two electrode zones 23.

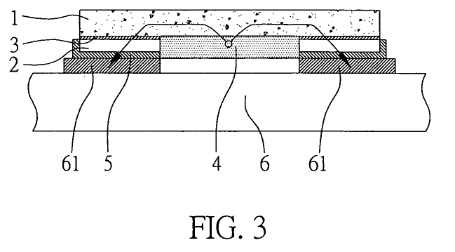

FIG. 3 is a diagram illustrating heat-conduction in application for an apertured fixed chip resistor provided by the present invention while being applied to an external device. As shown in the figure, the electrodes 5 on the surfaces of the two electrode zones of the apertured fixed chip resistor are soldered to corresponding circuit contacts 61 of a circuit of an external device 6, for example, a circuit board. In accordance with the structural design of the aforesaid apertured fixed chip resistor, the electrodes 5 are directly connecting to the metallic sheet structure 2. Therefore, when the metallic sheet structure 2 generates heat while operating, a thermo-conductive path exists as shown by the direction arrows in the figure. The passivation layer 4 has an insulative nature, and, consequently, the thermo-conductive path towards the substrate 1 has better thermo-conductivity. Then, the thermo-conductive path continues from the substrate 1 to the circuit contacts 61 via the electrodes 5 on the two terminals of the metallic sheet structure 2. Thereby, heat can be dissipated via the substrate 1, and, at the same time, be directly conducted into the printed circuit of the external device 6 via the circuit contacts. Thus, heat is prevented from being directly dissipated downwards (in the figure) to cause burning of the external device 6, for instance, a circuit board, and, consequently, immoderate variations of the temperature coefficient of resistance caused by an increasing or increased temperature of the electrodes 5 and metallic sheet structure 2 are avoided. Accordingly, the invention is further applicable to products of extremely low resistance.

In summary, the apertured fixed chip resistor and method for fabricating the same provided by the present invention apply a bonding layer to bond the substrate and the metallic sheet structure together in face-to-face orientation, thereby eliminating the drawback of the high cost of applying semiconductor fabrication processing as in prior art, and, consequently, achieving the objectives of a simple fabrication process, increased fabrication process yield, and decreased total cost. In addition, the two regions of the metallic sheet structure not covered by the passivation layer are formed indirectly through the formation of the central region, thus forming the two electrode zones, which are capable of serving as bases for electrodes for soldering purpose, or of directly being used as electrodes for soldering, thereby eliminating unnecessary current transmission impedance as in the prior art, and also efficiently and stably reducing the temperature coefficient of resistance. Therefore, the apertured chip resistor and the method for fabricating the same provided by the present invention have overcome the drawbacks of the prior art, and conform to the patent application requirements of industrial utility, novelty, and advancement.

The foregoing descriptions of the detailed embodiments are only provided to disclose the features and functions of the present invention and not to be considered restrictive of the scope of the present invention. It should be understood to those in the art that all modifications and variations made within the spirit and principles in the disclosure of the present invention should fall within the scope of the appended claims.

1. An apertured chip resistor, comprising:
a substrate;
a metallic sheet structure formed with a central aperture for defining the resistance of the metallic sheet structure;
a bonding layer for bonding the substrate and the metallic sheet structure together in face-to-face orientation; and
a passivation layer, which partially covers the metallic sheet structure, such that it divides the exposed surface of the metallic sheet structure into a covered portion and two opposed uncovered portions with the covered portion therebetween, the two uncovered regions being provided to serve as electrode zones.

2. The apertured chip resistor of claim 1, wherein the metallic sheet structure is an alloy of copper and manganese and tin.

3. The apertured chip resistor of claim 1, wherein the metallic sheet structure is a metal alloy of copper and manganese and nickel.

4. The apertured chip resistor of claim 1, wherein the shape of the central aperture is one of the shapes of a circle, square, rhombus, trapezoid and regular polygon.

5. The apertured chip resistor of claim 1, wherein the resistance of the metallic sheet structure is defined by area of the central aperture, and the resistance and the area of the central aperture are in direct proportion.

6. The apertured chip resistor of claim 1, wherein the passivation layer covers the surface of central region of the metallic sheet structure, such that it divides the surface into a central covered region extending to the sides and two opposed uncovered regions with the central region therebetween, the two uncovered regions being provided to serve as electrode zones.

7. The apertured chip resistor of claim 6, further comprises two electrodes, which are separately formed on the surfaces of the two electrode zones of the metallic sheet structure.

8. The apertured chip resistor of claim 1, wherein the passivation layer is made of an epoxy resin.

9. The apertured chip resistor of claim 1, wherein the substrate is a ceramic substrate.

10. The apertured chip resistor of claim 9, wherein the ceramic substrate is made of an aluminate oxide.

11. The apertured chip resistor of claim 1, wherein the bonding layer is either an entire layer of solder bumps or comprises at least two alternate solder bumps.

12. A fabrication method of an apertured chip resistor, comprising:
providing a substrate and a metallic sheet structure, wherein the metallic sheet structure has a central aperture for defining the resistance of the metal sheet;
bonding the substrate and the metallic sheet structure together via a bonding layer; and
applying a passivation layer to partially cover the surface of the metallic sheet structure, such that it divides the surface of the metallic sheet structure into a central covered region and two opposed uncovered regions with the central covered region therebetween, the uncovered regions being provided to serve as electrode zones.

13. The fabrication method of the apertured chip resistor of claim 12, wherein the central aperture of the metallic sheet structure is formed by means of either stamping or machining.

14. The fabrication method of the apertured chip resistor of claim 13, wherein the means of stamping the metallic sheet structure is a punching process.

15. The fabrication method of the apertured chip resistor of claim 13, wherein the means of machining is either a drilling process or a milling process.

16. The fabrication method of the apertured chip resistor of claim 12, wherein the bonding layer is either an entire layer of solder bumps or comprises at least two solder bumps.

17. The fabrication method of the apertured chip resistor of claim 16, wherein a solder material is pre-coated on a surface of the substrate, and then the metallic sheet structure is affixed on the substrate, and, after being subjected to a thermic welding process, the solder material transforms into the solder bumps that bond the substrate and the metallic sheet structure together.

18. The fabrication method of the apertured chip resistor of claim 16, wherein a solder material is pre-coated on a surface of the metallic sheet structure, and then the metallic sheet structure is affixed on the substrate, and, after being subjected to a thermic welding process, the solder material transforms into the solder bumps that bond the substrate and the metallic sheet structure together.

19. The fabrication method of the apertured chip resistor of claim 17, wherein the solder material is a silver paste.

20. The fabrication method of the apertured chip resistor of claim 17, wherein the solder material bonds and fixes the substrate and the metallic sheet structure together via a baking-welding process and a drying process.

21. The fabrication method of the apertured chip resistor of claim 12, wherein the passivation layer covers the exposed surface of the central region of the metallic sheet structure, such that it divides the surface of the metallic sheet structure into a central covered region and two opposed uncovered regions with the central region therebetween, the two uncovered regions being provided to serve as electrode zones.

22. The fabrication method of the apertured chip resistor of claim 12, further comprising: separately forming two electrodes on the surfaces of the two electrode zones of the metallic sheet structure.

23. The fabrication method of the apertured chip resistor of claim 22, wherein the electrodes are formed on surfaces of the electrode zones by means of rolling plating.
